(19) United States
(12) Patent Application Publication
(10) Pub. No.: US 2008/0208900 A1
(43) Pub. Date: Aug. 28, 2008

(54) Systems and methods for providing an enhanced status management service

(75) Inventor: Roman Rapp, Villeneuve-Loubet (FR)

Correspondence Address: SAP / FINNEGAN, HENDERSON LLP, 901 NEW YORK AVENUE, NW, WASHINGTON, DC, 20001-4413, US

(73) Assignee: SAP AG

(21) Appl. No.: 11/797,117

(22) Filed: May 1, 2007

(30) Foreign Application Priority Data
Feb. 28, 2007 (EP) 07 290 272.9

(51) Int. Cl. G06F 7/00

(52) U.S. Cl. 707/103 Y; 707/E17.005

(57) ABSTRACT

Systems and methods are provided for implementing an enhanced service-oriented architecture in a service-oriented architecture. The service-oriented architecture may include a plurality of foundation business objects and at least one dependent business object for providing an enhanced status management service for the plurality of foundation business objects. In one embodiment, a system comprises a plurality of foundation business objects, at least one dependent business object for providing an enhanced status management service for the plurality of foundation business objects, and means for instantiating one of the plurality of foundation business objects. The system may also comprise means for instantiating at least one dependent business object. Furthermore, an interface may be provided for each of the plurality of foundation business objects, wherein the interface comprises means for getting allowed statuses from the instantiated dependent business object for one or more roles associated with the instantiated foundation business object, and means may be provided for changing the status of the role specific object status associated with the instantiated foundation business object to one of the allowed statuses.

### TECHNICAL FIELD

The present invention generally relates to data processing systems and methods. More particularly, and without limitation, the present invention relates to computer-implemented systems and methods for providing enhanced status management services in a service-oriented architecture.

### BACKGROUND INFORMATION

A service-oriented architecture (SOA) includes a collection of data processing services that can communicate with each other. Such communication may involve data exchange and/or two or more services coordinating activities or data processing tasks. Conventional SOAs typically have some connecting infrastructure to provide communication between the data processing services and coordination.

Examples of known SOAs include Distributed Component Object Model (DCOM), based on the Common Object Request Broker Architecture (CORBA), which can interoperate with any other CORBA-based program across multiple operating systems, programming languages, and networks. DCOM, an extension of the Component Object Model (COM), is designed for use across multiple network transports, including Internet protocols such as HTTP. DCOM works with both Java applets and activeX components through its use of the COM.

SAP Enterprise Services Architecture (ESA), commercially available from SAP AG (Walldorf, Germany), is another recent SOA. ESA extends Web service standards and SOA principles to meet the needs of enterprise business solutions. ESA helps information technology (IT) organizations leverage existing systems to build and deploy flexible solutions that support end-to-end business scenarios across heterogeneous data processing systems.

SOAs may comprise foundation business objects and dependent business objects that provide a status management service for the foundation business objects. Previously, a generic status management service was proposed for any type of business object (BO). For a further understanding of this solution, see U.S. patent application Ser. No. 11/508,138, filed Apr. 28, 2006, the contents of which are herein incorporated by reference. This status management service could only handle the status of a BO. Often times, however, a process may use one or more BOs. It is necessary to be able to set the status of a BO, depending on different roles in a process, and the status of the BO may depend on the status of related BOs in the process.

### SUMMARY OF THE INVENTION

Embodiments of the present invention relate to systems, methods, and computer program products for facilitating the provision of an enhanced status management service (ESMS). Embodiments of the invention include systems and methods for providing an enhanced status management services in, for example, a service-oriented architecture or SOA.

Embodiments of the present invention may advantageously provide an ESMS that may be used by multiple instances of various foundation business objects. In particular, embodiments of the present invention may reduce the complexity of foundation business objects by eliminating the need for status management program routines specific to a respective foundation business object that can only handle the status of a BO. Such specific program routines can be replaced by an ESMS based on a dependent business object. For managing the status of a given instance of one of the foundation business objects, an instance of the dependent business object may be created that provides an ESMS and interacts with this instance of the foundation business object. Embodiments of the present invention may also allow the status of a BO to be set differently for different roles in a process.

In accordance with one embodiment, a computer-implemented system is disclosed for providing an enhanced status management service in an service-oriented architecture. The computer-implemented system may comprise a plurality of foundation business objects, at least one dependent business object for providing an enhanced status management service for the plurality of foundation business objects, means for instantiating one of the plurality of foundation business objects, and means for instantiating at least one dependent business object. An interface may be provided for each of the plurality of foundation business objects, wherein the interface comprises means for getting allowed statuses from the instantiated dependent business object for one or more roles associated with the instantiated foundation business object, and means may be provided for changing the status of the role specific object status associated with the instantiated foundation business object to one of the allowed statuses.

Embodiments of the present invention also relate computer-implemented methods for providing an enhanced status management service in a service-oriented architecture. In one embodiment, the computer-implemented method comprises an service-oriented architecture, the service-oriented architecture comprising a plurality of foundation business objects and a dependent business object to provide an enhanced status management service for the plurality of foundation business objects. The method may further comprises instantiating one of the foundation business objects, initiating the instantiation of the dependent business object by the instantiated one of the foundation business objects. The dependent business object may be operable to get allowed statuses from the instantiated dependent business object for one or more roles associated with the instantiated foundation business object, and change the status of the role specific object status associated with the instantiated foundation business object to one of the allowed statuses.

Embodiments of the present invention further relate to computer-readable medium including instructions which cause a processor to perform methods for providing an enhanced status management service in a service-oriented architecture, such as the method summarized above.

It is to be understood that both the foregoing general description and the following detailed description are exemplary and explanatory only, and should not be considered restrictive of the scope of the invention, as described in the claims. Further, features and/or variations may be provided in addition to those set forth herein. For example, embodiments consistent with the present invention may be directed to various combinations and subcombinations of the features described in the following detailed description.

### BRIEF DESCRIPTION OF THE DRAWINGS

The accompanying drawings, which are incorporated in and constitute a part of the specification, illustrate embodiments of the invention and, together with the description, serve to explain advantages and principles of the invention. In the drawings:

FIG. 1 is a block diagram of an exemplary data processing system having an SOA for providing an ESMS, consistent with an embodiment of the invention;

FIG. 2 is a class diagram illustrating exemplary foundation BOs having an interface to provide interoperability with a dependent BO that provides the ESMS, consistent with an embodiment of the invention;

FIG. 3 illustrates the exemplary structure of the dependent BO, consistent with an embodiment of the invention;

FIG. 4 illustrates a first configuration of the ESMS, consistent with an embodiment of the invention;

FIGS. 5A and 5B illustrate a second configuration of the ESMS, consistent with an embodiment of the invention;

FIG. 6 is a flowchart illustrating an exemplary method, consistent with an embodiment of the invention;

FIG. 7 is a sequence diagram illustrating the exemplary assignment of a default status to an instantiated foundation BO by the ESMS, consistent with an embodiment of the invention;

FIG. 8 is a sequence diagram illustrating the exemplary execution of a status change of an instantiated foundation BO using the ESMS, consistent with an embodiment of the invention; and

FIG. 9 is a sequence diagram illustrating exemplary communication of allowed actions that can be performed on an instantiated foundation BO from the ESMS.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible without departing from the spirit and scope of the invention. For example, substitutions, additions, or modifications may be made to the components illustrated in the drawings, and the exemplary method described herein may be modified by substituting, reordering, or adding steps to the disclosed methods. Accordingly, the following detailed description does not limit the invention. Instead, the proper scope of the invention is defined by the appended claims.

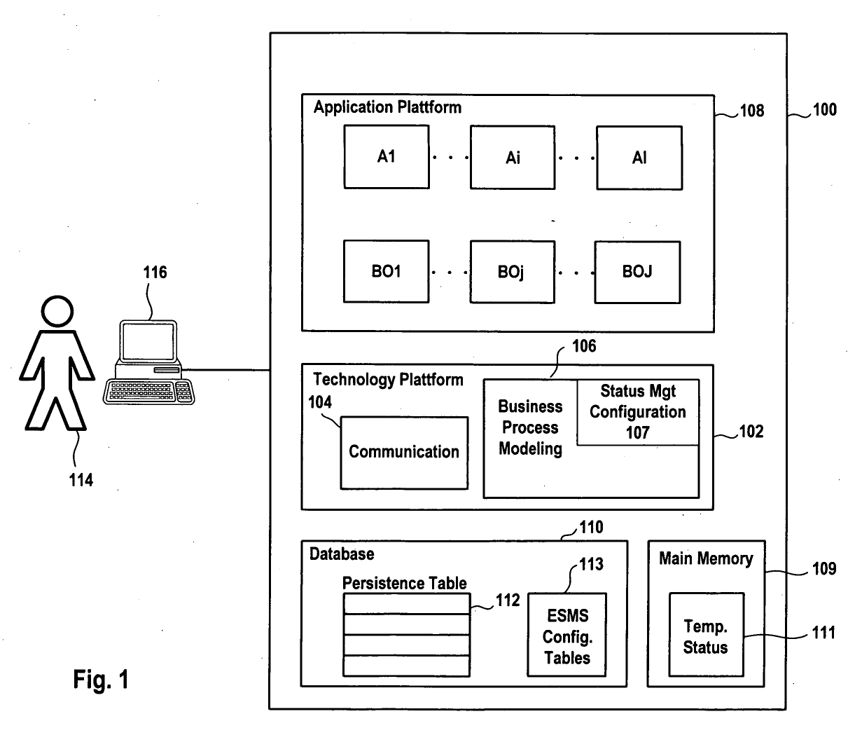

FIG. 1 shows an exemplary data processing system 100 that has an SOA, such as SAP's Enterprise Services Architecture (ESA). The data processing system 100 can be physically distributed over a number of computer systems that are interconnected by one or more networks. Further, the various networked computer systems constituting data processing system 100 can use a number of different operating systems and programming languages.

The SOA has a technology platform 102 that provides the “glue” that binds various computer systems to form the data processing system 100. Technology platform 102 has a communication component 104 that enables the exchange of data across the various computer systems and networks. For example, communication component 104 can be implemented with the SAP Exchange Infrastructure (XI).

The technology platform 102 also includes a business process modeling component 106 that serves to coordinate the interchange of data in the SOA in accordance with certain business procedures. It can be implemented, for example, by the product ARIS, which is commercially available from IDS Scheer AG (Germany). As shown in FIG. 1, the SOA of data processing system 100 also includes an application platform 108 that uses the infrastructure provided by the technology platform 102 and implements business logic. The application platform 108 may have an arbitrary number “I” of application programs (i.e., A1, . . . , Ai, . . . , AI).

Further, application platform 108 has an arbitrary number “J” of BOs (i.e., BO1, . . . , BOj, . . . , BOJ). The BOs of application platform 108 may be implemented as SAP BOs. In one embodiment, the services of SAP BOs describe complete elementary steps in business processes, such as making a purchase order, providing a product cost estimate, invoicing a customer for a service, etc. These services can be implemented as methods of BOs. The encapsulation of the description of a complete business process in such a BO reduces complexity because the inner structure of the BO remains concealed. By invoking services of the BOs, the external applications A1, . . . , AI can access and manipulate the BOs BO1, . . . , BOJ, via the Internet, SAP Exchange Infrastructure (XI), DCOM or CORBA, or the like.

While the individual BOs describe complete elementary steps in business processes, the business process modeling component 106 of the technology platform 102 describes complex workflows that involve multiple business process steps and, thus, respective BO services. Business process modeling component 106 may include a status management configuration 107 that may be a software application or module that allow for a user to define the roles, status, and processes associated with each of the BOs, as will be described further below with regard to tables 113.

For the exemplary embodiments disclosed herein, two kinds of BOs are relevant: foundation BOs and dependent BOs. By definition, an instantiated foundation BO is not dependent on any other BO or instance of a BO. Further, by definition, an instantiated dependent BO has a dependency relationship with an instantiated foundation BO.

Data processing system 100 has at least one database 110. The database 110 can be a single physical database or it can be a distributed database using multiple computer systems of the data processing system 100. Database 110 serves as storage of persistence tables 112 for storage of instances of BOs and events, enabling the interchange of asynchronous messages and auditing of the business processes. Further, at least one of persistence tables 112 serves as storage of the statuses of the instances of foundation BOs.

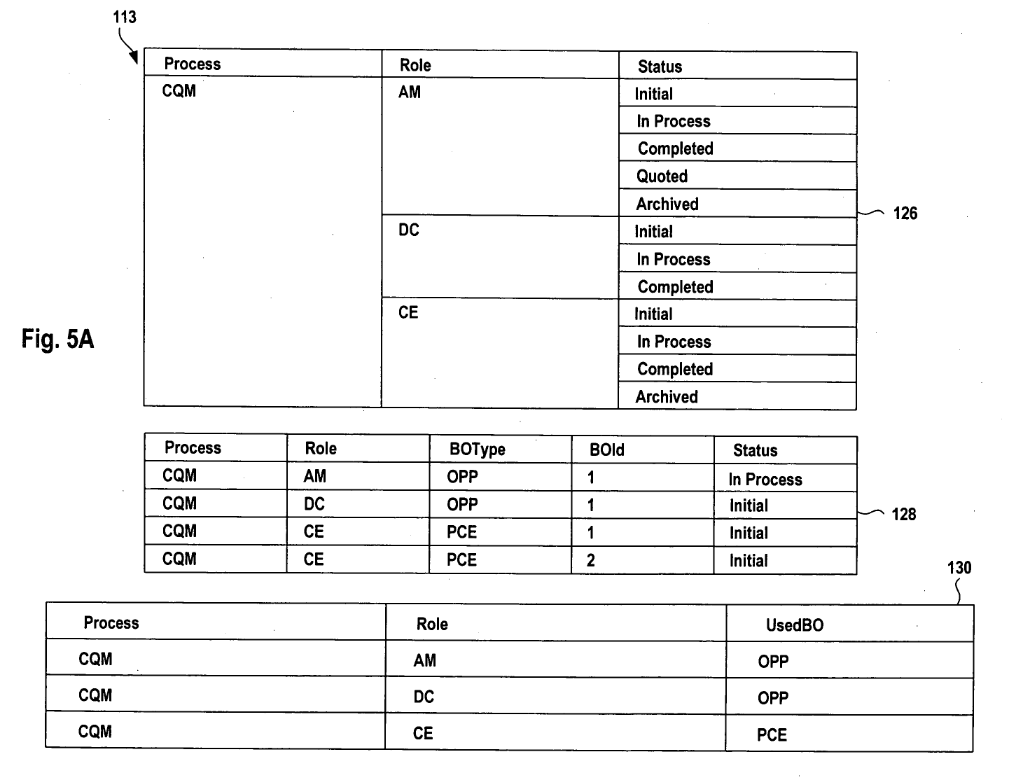

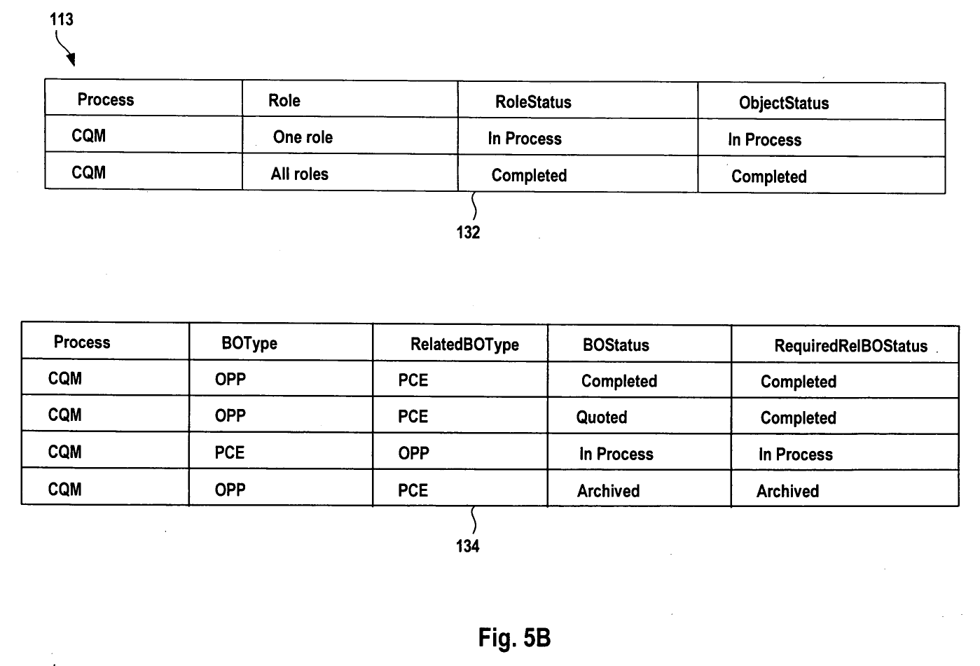

As shown in FIG. 1, one or more tables 113 are also stored in the database 110 for storage of a configuration of the ESMS. For example, tables 113 may specify the actions that can be performed on instances of foundation BOs; the statuses that at least some of the instances of the foundation BOs, can take; actions that can be performed on instantiated foundation BOs, depending on status and/or foundation BO type and/or foundation BO keys; what BO type is used per role in a process; and/or dependencies between the object status and the role. Examples of the structure and content of tables 113 are given below with reference to FIGS. 4, 5A, and 5B.

The data processing system 100 has a volatile main memory 109 for storing a temporary status 111 of an instantiated foundation BO that is currently being processed, for example, by one of the external applications. The temporary status 111 is the actual status of the respective instantiated foundation BO that is temporarily held in the main memory 109. After processing of the instantiated foundation BO is successfully completed, a save command is received, for instance, from the external application that has performed the processing, such that the temporary status 111 is stored in the respective persistence table 112. A respective status that has been previously stored in the persistence table 112 for that instantiated foundation BO may be overwritten by the temporary status 111 in response to the save command. If execution of the external application is terminated unsuccessfully, the temporary status 111 is not stored in the persistence table 112, and the original status is kept.

By way of example, FIG. 1 shows a user 114 and his or her personal computer 116 that is coupled to the data processing system 100. Although only one user 114 is illustrated, data processing system 100 may be coupled to any number of users, depending on, for example, the size of the organization that operates the data processing system 100. User 114 may also be an application software developer.

User 114 may be an employee who performs a certain action, item, or task requiring the use of one or more of the external application programs A1, . . . , AI of the application platform 108 and instantiation of one or more of the foundation BOs of the application platform 108.

For execution of an action item, the user 114 enters data into his or her personal computer (PC) or other processing platform 116 for instantiating the respective foundation BO that implements the elementary business process for execution of the action item.

Alternatively, one of the external application programs A1, . . . , AI is invoked automatically and instantiates one or more of the foundation BOs without user interaction.

At least one of the BOs BO1, . . . , BOj contained in the application platform 108 is not a foundation BO but a dependent BO. A service of a dependent BO also describes an elementary business process step. However, the dependent BO differs from a foundation BO in that an instantiated dependent BO requires a dependency relationship to an instantiated foundation BO.

For example, a BO for a request for a quote is the BO BO1 (also called OPP). In this instance, user 114 enters data into his or her personal computer 116 for instantiating the BO BO1. The instantiated BO BO1 initiates the instantiation of a dependent BO BOj that provides the enhanced status management service. After instantiation of the dependent BO BOj, the instantiated dependent BO BOj executes the ESMS as specified in the tables 113 in order to provide an initial status, to execute a status change, and/or to communicate allowed actions that can be performed on the initiated foundation BO, depending on its actual status, the role associated with a foundation BO and the status of a related BO.

Implementing the steps of an enhanced status management process in a separate dependent BO has the advantage that no such status management process needs to be included into the various foundation BOs. This can substantially reduce the quantity of software (e.g., lines of programming code) required for implementation of the foundation BOs.

Another advantage is increased flexibility. If the enhanced status management process needs to be changed, only the dependent BO that provides the ESMS and/or one of the tables 113 needs to be changed correspondingly, but not the foundation BOs themselves.

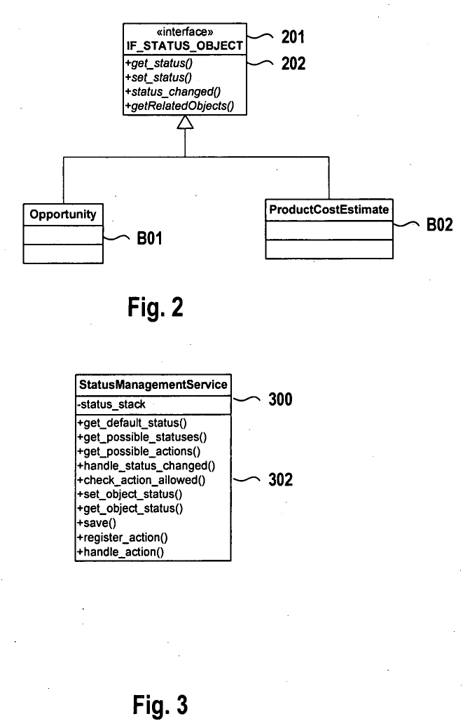

FIG. 2 schematically shows an interface 201 that is implemented by exemplary foundation BOs in order to provide interoperability with the dependent BO BOj that provides the ESMS. In the example considered here, there are foundation BOs BO1 “Opportunity” and BO2 “ProductCostEstimate.”

The interface 201 may contain one or more methods 202, such as the method “get_status” for getting a status of the respective instantiated foundation BO, “set_status” for setting an updated status, and “status_changed” for signaling that the status has been changed.

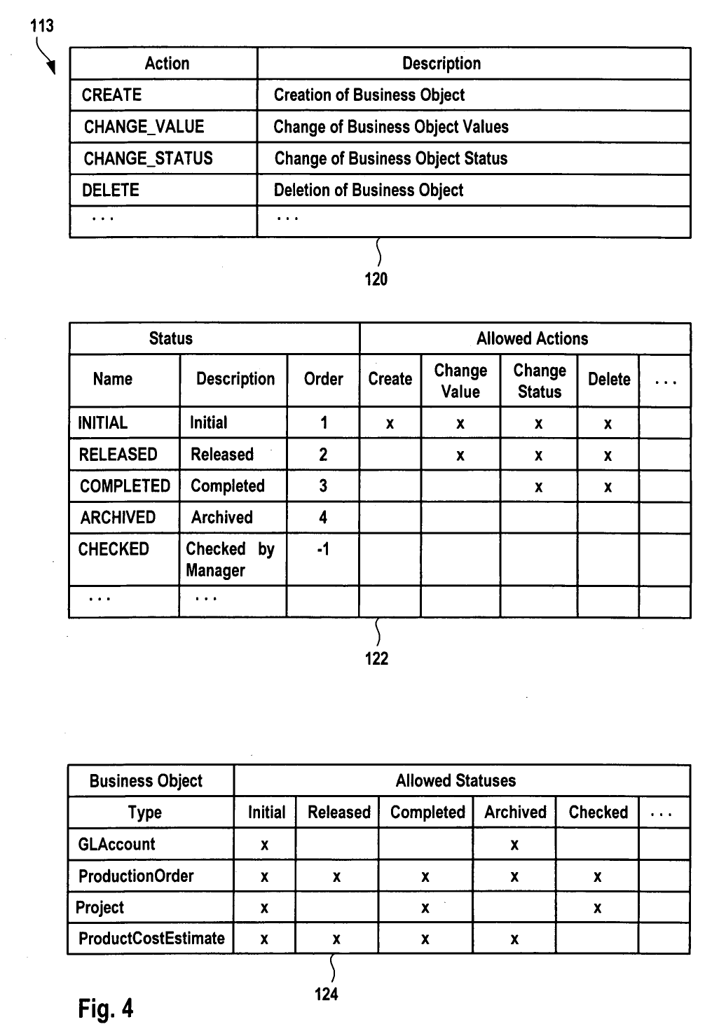

FIG. 3 schematically shows an exemplary structure of the dependent BO BOj that provides the ESMS, if instantiated. The BO BOj has a header 300 that contains a status stack and a body 302 that contains various methods and class methods, including “get_default_status,” “get_possible_statuses,” “get_possible_actions,” “handle_status_changed,” “check_action_allowed,” “set_object_status,” “get_object_status,” “save,” “register_action,” and “handle_action.”

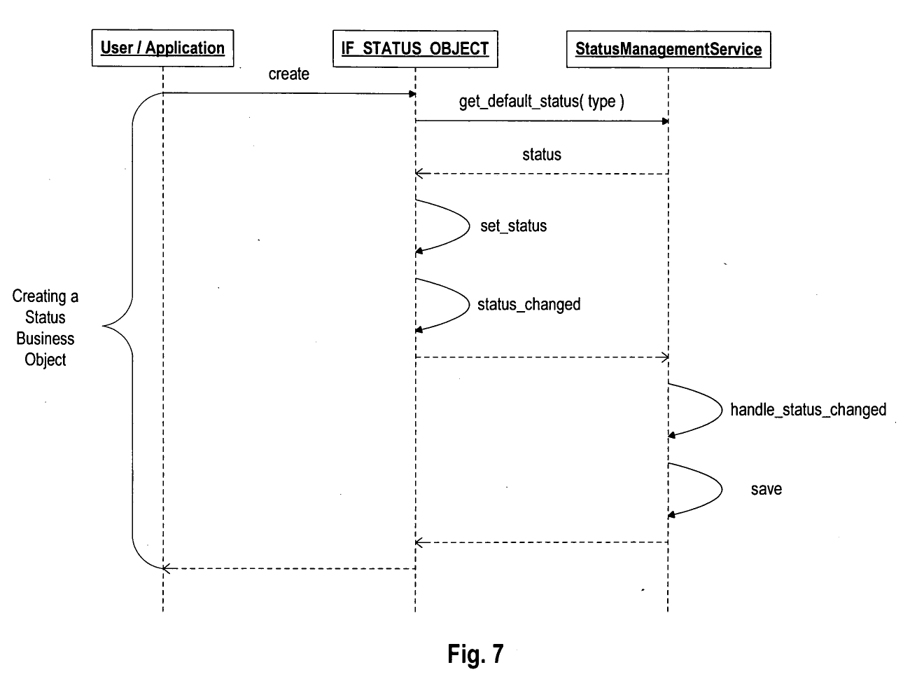

The difference between a method and a class method is that a method can be called after instantiation, whereas a class method can be called before instantiation of the dependent BO. The functionalities of these methods and class methods will be explained in more detail below with reference to FIGS. 7-9.

FIG. 4 shows a more detailed example of an implementation of the tables 113 that configure the ESMS. In the embodiment considered here, the ESMS configuration tables 113 include three tables 120,122, and 124. The table 120 contains a definition of the actions that can be performed on at least some of the foundation BOs. This may comprise the action “Create” for creation of a new instance of a foundation BO, “Change_Value” for changing one or more values of an instantiated foundation BO, “Change_Status” for changing the status of an instantiated foundation BO, and “Delete” for deletion of an instantiated foundation BO, etc.

Table 122 contains a definition of the statuses that can be taken by at least some of the foundation BOs. A set of allowed actions is assigned to each of the statuses in order to specify the actions that can be performed on an instantiated foundation BO in that status.

For instance, the allowed actions “Create,” “Change_Value,” “Change_Status,” and “Delete” are assigned to the status “Initial;” the allowed actions “Change_Value,” “Change_Status” and “Delete” are assigned to the status “Released” and the allowed actions “Change_Status and “Delete” are assigned to the status “Completed.” No allowed actions are assigned to the statuses “Archived” and “Checked.”

In addition, table 122 specifies the order in which an instantiated foundation BO can transition from one of the defined statuses to another. In the embodiment considered here, this order is as follows: 1=Initial, 2=Released, 3=Completed, and 4=Archived. In other words, an instantiated foundation BO may transition from “Initial” to “Released” to “Completed” and finally to “Archived” only in this specified order. The status “Checked” has no order and is indicated by order=−1 in the table 122. This means that the status “Checked” can be taken by an instantiated foundation BO independently from the other defined statuses.

The table 124 specifies the allowed statuses for each of the foundation BOs. An instance of the foundation BO Opportunity (OPP) can take one of the allowed statuses “Initial” or “Archived”. An instance of the foundation BO Product-Cost Estimate (PCE) can take one of the allowed statuses “Initial,” “Released,” “Completed,” or “Archived.” For example, in conjunction with the table 122, this means that an instance of the foundation BO opportunity can transition from “Initial” to “Completed” to “Archived” in accordance with the order specified in table 122, leaving out those statuses that are not allowed for the considered foundation BO.

FIG. 5A shows another set of exemplary implementations of tables 113 for specifying the ESMS. Table 126 specifies which status can be set for a BO by each role in a process. An example of a cost and quotation management process (CQM) is presented in table 126. The process CQM in this example has three roles associated with it: an account manager (AM), a document controller (DC), and a cost estimator (CE). The AM may receive the request for a quote from a customer and manage it. The DC may prepare and clean the attached customer documents to a quote, and the CE may be responsible for preparing the cost of the products in the quote. In table 126, the role AM can only set a BO status to “Initial,” “In Process,” “Completed,” “Quoted,” and “Archived.” The role DC can only set a BO status to “Initial,” “In Process,” or “Completed.” The role CE can only set a BO status to “Initial,” “In Process,” “Completed,” or “Archived.” In one embodiment, the status of the BO may also be dependent on the BO type. For example, if a role uses several BOs in a process, so e.g. for process CQM and role AM, the BO OPP had an allowed status of “Initial,” and the BO OPP had an allowed status of “In Process,” then the role of AM can set a status of “Initial” to a BO if the BO type is OPP.

Table 128 stores the current status of each BO within a process. In the example shown in table 128, each role is associated with a “BOType” as well as a “BOld” and a “BO” status. Every time a BO is created, this table may be populated with a default status for the role based on the BOType. For example, for the role AM, the BOType OPP, the BO status is “In Process.” When a status of a BO is changed within a process, the status is changed in this table.

FIG. 5A also shows another set of exemplary implementations of tables 113 for specifying the ESMS. Table 130 specifies the foundation BO that is used per role. An instance of the foundation BO OPP can be used by the role AM or DC. An instance of the foundation BO PCE can be used only by the CE role.

In FIG. 5B, table 132 specifies the dependencies between the status of each foundation BO and the status of each role. These statuses are valid for all BOs that a role will handle during the process. For the process CQM, the overall object status will be set to “In Process” as soon as one role sets the status to “In Process” for any BO. For example, if in the CQM process, the AM role used the BOs OPP and PCE, then as soon as the role AM sets the status to “In Process,” the object status for OPP and PCE is also set to “In Process.” The BO status will automatically be set to “Completed” once all the roles have set the status to “Completed” in the process according to table 132. Therefore, the BO status of OPP and PCE will only be set to “Completed” once all the roles used in the process are set to “Completed.” In this example, once the roles AM, DC, and CE are set to “Completed,” then the BOs OPP and PCE can be set to “Completed.”

In one embodiment, a further column could be added to make the overall object status dependent on the BO type (not pictured). This is the case if the role uses several BOs in one process. Then the role can set different status for different BOs. For example, for process CQM and role AM, if the following were true:
BO allowed status
OPP Initial
OPP In Process
OPP Quoted
OPP Archived
PCE Initial
PCE Quoted

Then the role AM can set different statuses for different BOs. Table 134 specifies the dependencies between the allowed status of a foundation BO and the status of a related BO. Therefore, the status of a BO would not change unless the status of a related BO is set to a particular status, as defined by table 134. For example, the status of the OPP can only be set to “Completed” if the status of the BO PCE is also set to “Completed.” In another example, the OPP can only be set to “Archived” if the related BO PCE was set to “Archived” previously.

Each of the tables 113 may be populated initially by user 114 using the status management configuration 107 of the business modelling process 106.

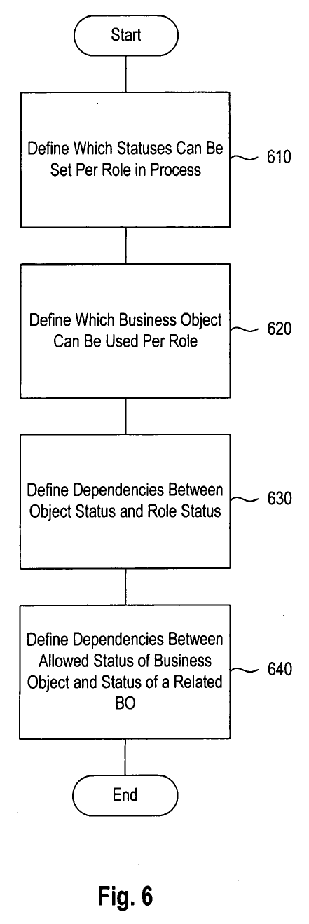

FIG. 6 is a flowchart illustrating an embodiment of a method for configuring the ESMS, consistent with an embodiment of the present invention. In step 610, the statuses that can be set for each role for a process are defined by user 114 using status management configuration 107. A status refers to the stage in the process associated with each role. A status may be “Initial,” meaning the role has not participated in the process. “In Process” refers to a status indicating the role is participating in the process currently. “Completed” refers to the role having completed working on the process. “Quoted” refers to the having sent the completed process to the customer. Therefore, the quote cannot be changed any further. “Archived” refers to the process being deleted from the database it is stored in, and stored in an archive file instead.

For example, referring to table 126 shown in FIG. 5A, the status “Initial,” “In Process,” and “Completed,” can be set for the role DC.

Once the statuses that can be set for each role are defined, the BO type used per role is then defined by user 114 using status management configuration 107 (step 620). In a given process, each role may be associated with one or more BOs. If a BO is associated with a role, then the role can use the BO for the functions related to the process. Referring to table 130 shown in FIG. 5A, for the role AM, the BO type used is OPP, and the BO type for the role CE is PCE.

After the BO type used per role is defined, the dependencies between the object status and the role specific object status are defined by user 114 (step 630), as shown in table 132 shown in FIG. 5B. As stated earlier, the statuses are valid for all BOs that a role will handle during the process. In this step, the relationship is between the object status and the role specific object status is defined. The object status may be set according to one or more role specific object statuses. An object status may not be changed unless a particular role specific object status is set according to a user-defined status. The object status may also depend on more than one role specific object status.

After the dependencies between the object status and the role specific object status are defined, the dependencies between the allowed status of a BO and a status of a related BO may be defined by user 114 (step 640). As described above, table 134 (FIG. 5B) specifies the dependencies between the allowed status of a foundation BO and the status of a related BO. Therefore, the status of a BO would not change unless the status of a related BO is set to a particular status.

A foundation BO is instantiated automatically or by involving some degree of user interaction. In order to provide an ESMS for the instantiated foundation BO, the dependent BO BOj is instantiated. In response to a respective method call, the instantiated dependent BO BOj provides the default status to the instantiated foundation BO.

FIG. 7 shows a sequence diagram, making reference to the examples shown in FIGS. 2 and 3. The sequence diagram involves the objects “User/Application” (cf. user 114 and one of the applications of the application platform 108 of FIG. 1), “IF STATUS_OBJECT” (cf. interface 201 as shown in FIG. 2), and “Status Management Service”; in other words, an instance of the dependent BO BOj for providing the ESMS as depicted in FIG. 3).

When an instance of one of the foundation BOs is created, it receives a default status defining the actions that can or cannot be performed on it. First, the user 114 or an application instantiates one of the foundation BOs (e.g., a production order for an existing product) including the respective “IF_STATUS_OBJECT” interface 201. By means of the interface 201, the method “get_default_status” of the status management service BOj is called in order to set an initial status by means of the method “set_status” of the interface 201. This done, the instantiated foundation BO raises the “status_changed” event by means of its interface 201. This event message triggers the ESMS in order to handle that message with “handle_status_changed”. Finally the changed status is persistently saved in one of the persistence tables 112 (cf. FIG. 1).

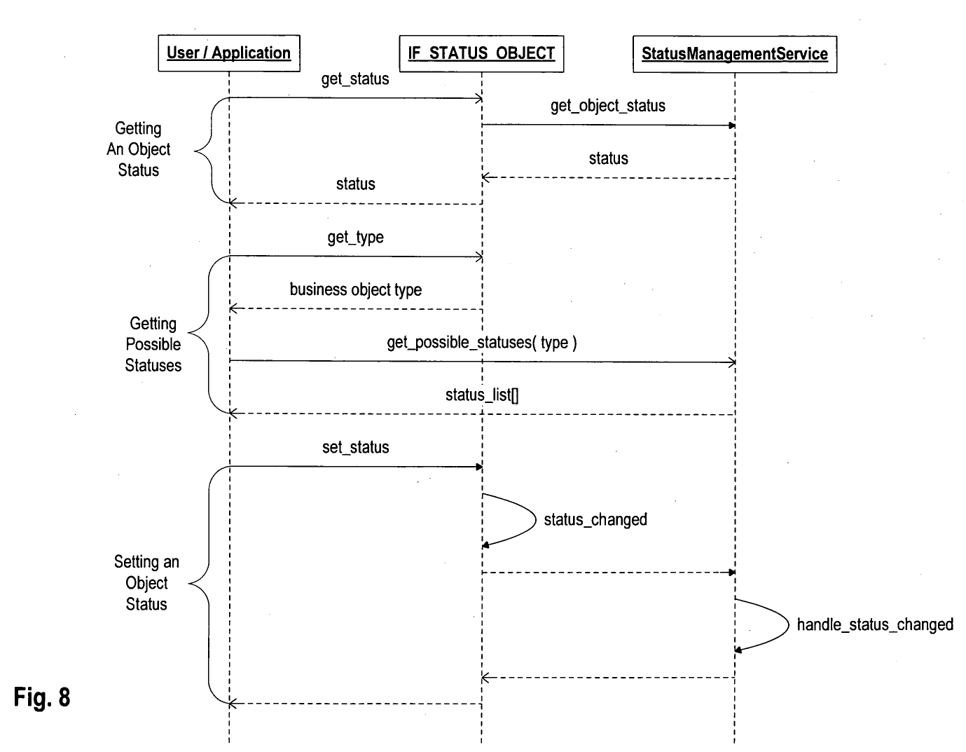

FIG. 8 shows a sequence diagram for changing a status during the life cycle of the instantiated BO. In the illustrated embodiment, the status of the instantiated foundation BO can be retrieved and/or changed by the user 114 or an application. With each change, the ESMS ensures that dependent objects also have their status changed correspondingly in order to keep the data model synchronized with the database, if necessary.

After the actual status of the instantiated foundation BO has been obtained by calling the methods “get_status” and “get_object_status,” the user or the application can obtain possible statuses to which the instantiated foundation BO can transition from its actual status by means of the method “get_type” and “get_possible_statuses.” A status change can be performed by calling the method “set_status.” The methods “get_object_status,” “get_object_status,” and “get_possible statuses” have BO, role, and process as input parameters.

When these methods are being called by an application using the ESMS, the application must know, if it uses the enhanced version (with role status) called ESMS or the first version (BO overall status only) referred to as Status Management Service (SMS). In the first case, it must provide the input parameters for role and process, so table 128 and the corresponding configuration can be read. In the second case, the two parameters are initial and only the BO overall status can be determined.

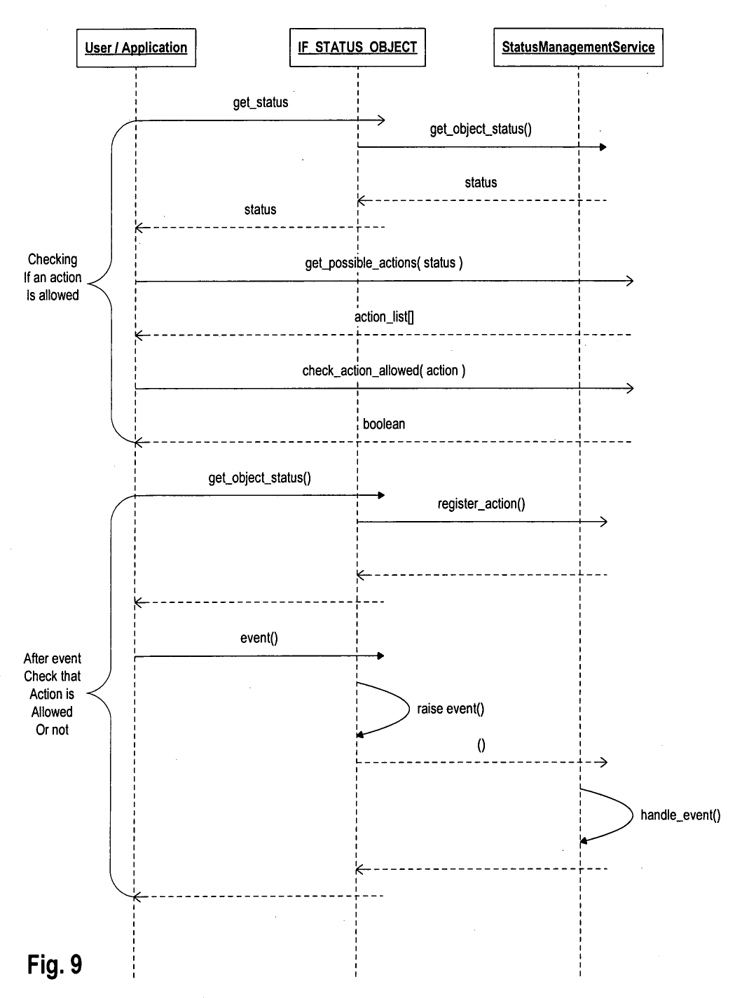

FIG. 9 shows a sequence diagram for an exemplary interchange of messages and method calls for checking if an action is allowed. Checking whether an action is allowed can be performed by calling the methods “get_status,” “get_object status,” “get_possible_actions (status),” and “check_action_allowed (action).” Alternatively, or in addition, such a check is performed after an event using the methods “get_object_status,” “register_action,” “event,” “raise_event” and “handle_event”.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software, or in hardware alone. Additionally, although aspects of the invention are described for being stored in memory, one skilled in the art will appreciate that these aspects can also be stored on other types of computer-readable media, such as secondary storage devices, for example, hard disks, floppy disks, or CD-ROMS, the Internet or other propagation medium, or other forms of RAM or ROM.

Computer programs based on the written description and flowcharts of this invention are within the skill of an experienced developer and/or programmer. The various programs or program content can be created using any of the techniques known to one skilled in the art or can be designed in connection with existing software. For example, programs or program content can be designed in or by means of Java, C++, HTML, XML, or HTML with included Java applets or in SAP R/3 or ABAP. One or more of such content can be integrated in existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations, and/or alterations as would be appreciated by those in the art based on the present disclosure. The limitations in the claims are to be interpreted broadly based on the language employed in the claims and not limited to examples described in the present specification or during the prosecution of the application, which examples are to be construed as nonexclusive.

As disclosed herein, embodiments and features of the invention may be implemented through computer hardware and/or software. Such embodiments may be implemented in various environments, such as networked and computer-based environments with one or more users. The present invention, however, is not limited to such examples, and embodiments of the invention may be implemented with other platforms and in other environments.

By way of example, embodiments of the invention may be implemented using conventional personal computers (PCs), desktops, hand-held devices, multiprocessor computers, pen computers, microprocessor-based or programmable consumer electronics devices, minicomputers, mainframe computers, personal mobile computing devices, mobile phones, portable or stationary personal computers, palmtop computers, or the like.

The storage mediums and databases referred to herein symbolize elements that temporarily or permanently store data and instructions. Although storage functions may be provided as part of a computer, memory functions can also be implemented in a network, processors (e.g., cache, register), or elsewhere. While examples of databases have been provided herein, various types of storage mediums can be used to implement features of the invention, such as a read only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM) or a digital versatile disk (DVD); (c) semiconductor media, like DRAM, SRAM, EPROM, EEPROM, memory stick, and/or by any other media, like paper.

Embodiments of the invention may also be embodied in computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, Intranets, and the Internet (i.e., the World Wide Web). The network can be a wired or a wireless network. To name a few network implementations, the network is, for example, a local area network (LAN), a wide area network (WAN), a public switched telephone network (PSTN), an Integrated Services Digital Network (ISDN), an infrared (IR) link, a radio link, such as a Universal Mobile Telecommunications System (UMTS), Global System for Mobile Communication (GSM), Code Division Multiple Access (CDMA), or a satellite link.

While certain features and embodiments of the invention have been described, other embodiments of the invention will be apparent to those skilled in the art from consideration of the specification and practice of the embodiments of the invention disclosed herein. Further, the steps of the disclosed methods may be modified in any manner, including reordering steps and/or inserting or deleting steps, without departing from the principles of the invention.

It is therefore intended that the specification and examples be considered as exemplary only, with a true scope and spirit of the invention being indicated by the following claims.

What is claimed is:

1. A computer-implemented system for providing an enhanced status management service in an service-oriented architecture, said system comprising:
a plurality of foundation business objects;
at least one dependent business object for providing the enhanced status management service for the plurality of foundation business objects;
means for instantiating one of the plurality of foundation business objects; and
means for instantiating at least one dependent business object;
wherein said plurality of foundation business objects each include an interface, and wherein said interface comprises:
means for getting possible allowed statuses from the instantiated dependent business object for one or more roles associated with the instantiated foundation business object, and
means for changing the status of the role specific object status associated with the instantiated foundation business object to one of the allowed statuses.

2. The system of claim 1, wherein said interface further comprises:
means for obtaining one or more roles that are allowed to perform one or more actions on the instantiated foundation business object from the instantiated dependent business object; and
means for allowing the one or more roles to perform the one or more actions on the foundation business object.

3. The system of claim 1, wherein said interface further comprises:
means for checking whether an action to be performed by one or more roles on the instantiated foundation business object is allowed based on the instantiated dependent business object.

4. The system of claim 2, wherein said interface further comprises:
means for getting one or more dependencies between the status of the foundation business object and the status of the one or more roles from the instantiated dependent business object; and
means for determining whether the status of the foundation business object can be changed based on the dependencies.

5. The system of claim 4, wherein said interface further comprises:
means for changing the status of the foundation business object based on a result from the means for determining.

6. The system of claim 1, wherein said interface further comprises:
means for getting one or more dependencies between the allowed status of the foundation business object and the allowed status of a related business object from the instantiated dependent business object; and
means changing the status of the foundation business object based on the dependencies.

7. The system of claim 1, said dependent business object further comprising:
means for defining a status to associate with the one or more roles;
means for defining which of the plurality of foundation business objects can be used by each of the one or more roles;
means for defining one or more dependencies between the status of each foundation business object and the status of each role associated with the foundation business object; and
means for defining one or more dependencies between the allowed status of the foundation business objects and the status of one or more related foundation business objects.

8. A computer-implemented method for providing an enhanced status management service in an service-oriented architecture, the service-oriented architecture comprising a plurality of foundation business objects, and a dependent business object for providing the enhanced status management service for the plurality of foundation business objects, the method comprising:
instantiating one of the foundation business objects; and
initiating the instantiation of the dependent business object by the instantiated one of the foundation business objects;
wherein the dependent business object is operable to:
get allowed statuses from the instantiated dependent business object for one or more roles associated with the instantiated foundation business object, and
change the status of the role specific object status associated with the instantiated foundation business object to one of the allowed statuses.

9. The method of claim 8, further comprising:
obtaining one or more roles that are allowed to perform one or more actions on the instantiated foundation business object from the instantiated dependent business object; and
allowing the one or more roles to perform the one or more actions on the foundation business object.

10. The method of claim 8, further comprising:
checking whether an action to be performed by one or more roles on the instantiated foundation business object is allowed based on the instantiated dependent business object.

11. The method of claim 8, further comprising:
getting one or more dependencies between the status of the foundation business object and the status of the one or more roles; and
determining whether the status of the foundation business object can be changed based on the dependencies.

12. The method of claim 11, further comprising:
changing the status of the foundation business object based on the determining.

13. The method of claim 9, further comprising:
getting one or more dependencies between the allowed status of the foundation business object and the allowed status of a related business object; and
changing the status of the foundation business object based on the dependencies.

14. A computer-readable medium which stores a set of instructions which when executed performs a method for providing an enhanced status management service in an service-oriented architecture, the service-oriented architecture comprising a plurality of foundation business objects, and a dependent business object for providing the enhanced status management service for the plurality of foundation business objects, the method comprising:
instantiating one of the foundation business objects; and
initiating the instantiation of the dependent business object by the instantiated one of the foundation business objects;
wherein the dependent business object is operable to:
get allowed statuses from the instantiated dependent business object for one or more roles associated with the instantiated foundation business object, and
change the status of the role specific object status associated with the instantiated foundation business object to one of the allowed statuses.

15. The computer-readable medium of claim 14, further comprising:
obtaining one or more roles that are allowed to perform one or more actions on the instantiated foundation business object from the instantiated dependent business object; and
allowing the one or more roles to perform the one or more actions on the foundation business object.

16. The computer-readable medium of claim 14, further comprising:
checking whether an action to be performed by one or more roles on the instantiated foundation business object is allowed based on the instantiated dependent business object.

17. The computer-readable medium of claim 14, further comprising:
getting one or more dependencies between the status of the foundation business object and the status of the one or more roles; and
determining whether the status of the foundation business object can be changed based on the dependencies.

18. The computer-readable medium of claim 17, further comprising:
changing the status of the foundation business object based on the determining.

19. The computer-readable medium of claim 15, further comprising:
getting one or more dependencies between the allowed status of the foundation business object and the allowed status of a related business object; and
changing the status of the foundation business object based on the dependencies.
